(19) United States
(12) Patent Application Publication
(10) Pub. No.: US 2012/0051724 A1
(43) Pub. Date: Mar. 1, 2012

(54) INSTANTANEOUS WATER HEATING UNIT FOR INSERTION INTO A HOT WATER STORAGE TANK

(76) Inventor: Moshe Abraham, Rosh Ha'ayin (IL)

(21) Appl. No.: 13/318,746

(22) PCT Filed: Apr. 26, 2010
(86) PCT No.: PCT/IL10/00336

§ 371 Date: Nov. 3, 2011

(30) Foreign Application Priority Data
May 7, 2009 (IL) 198642

(51) Int. Cl. F24H 1/20

(52) U.S. Cl. 392/441

(57) ABSTRACT

The present invention is an instantaneous water heating unit for retrofitting hot water storage tank. The instantaneous water heating unit is used to replace the original flange of an existing water storage tank. According to an embodiment of the present invention, the instantaneous water heating unit comprises to flange which contains a) a sleeve, having an opening at its top end, adapted to be positioned on the bottom surface of the water storage tank, wherein the sleeve extends at least above the mid-height of the water storage tank for discharging water from the water storage tank into the inner space of the sleeve; b) an electric water immersion heater positioned in the inner space of the sleeve; c) means for controlling the operation of the electric water immersion heater; d) a hot water outlet transfer pipe extending downwardly from the inside of the sleeve and having a length sufficient to position the outlet of the pipe in an lowermost volume of the water storage tank, thus when the sleeve is inserted into the water storage tank, the water within inner space of the sleeve being heated on-demand by the electric water immersion heater while flowing through the inner space of the sleeve; and e) a flow switch connected in line with the hot water outlet for sensing the opening of a hot water faucet.

### FIELD OF THE INVENTION

The present invention relates to the field of water heating systems. More particularly, the invention relates to an energy efficient water heater apparatus for providing on demand hot water.

### BACKGROUND OF THE INVENTION

Water heaters having internal electric resistance heating elements are well-known and in common use, both domestically and commercially. Conventional designs of this type typically consist of a water tank into which cold water is introduced near its bottom, and water heated by the elements is removed from its top. The water heaters are usually in the form of one or more metallic sheathed electric resistance heating elements, which extend into the tank from its inner sidewall and are fully exposed to the water in the tank.

As a person skilled in the art would know, water heater recovery rate is directly related to a water heater's capacity to heat an amount of cold water introduced into the tank in response to removal of heated water. Over the years, various improvements upon water heater designs have been developed, some for the specific purpose of improving recovery rate. Some of these improvements have related to ways of improving direct heat transfer from heating elements to water, such as IL 59,569 and IL 78,015, which consist of a sleeve around the heating element which transfers the heated water toward the upper zone of the tank while throttling the flow by an orifice or external valve.

Other solutions are disclosed in U.S. Pat. No. 4,282,421 that consists of a heating element sleeve and a combination of heat exchangers for pre-heating the water; U.S. Pat. No. 4,551,613 that consists of a heating element surrounding the pipe all along its length up to the discharge outlet; U.S. Pat. No. 4,403,137 that consists of a sleeve perforated all along its length; U.S. Pat. No. 4,514,617 and U.S. Pat. No. 6,321,036 that consist of an apparatus for producing hot water for consumption flowing through the sleeve.

Solar water heaters, also called solar domestic hot water systems, can be a cost-effective way to generate hot water. They can be used in any climate, and the energy they use—sunshine—is free. Usually, solar water heating systems include a storage tank and solar collectors. Most solar water heaters require a well-insulated storage tank. Solar storage tanks have an additional outlet and inlet connected to and from the collector. In many systems, the back-up heater is combined with the solar storage in one tank. Solar water heaters with electrical back-up capacity are designed to store quite a large quantity of water due to the virtually “free energy” coming directly from the sun for most of the year. In case of shortage of hot water due to weather conditions or malfunction of the system, there is a need to use electrical energy in order to supply sufficient hot water for household use. The main problem with such an electrical back-up system is the large quantity of water, often all of the water present in the hot water tank, to be heated, which means that a huge amount of electrical energy will be spent for long periods of time. Another difficulty is related to the inconvenience in determining the quantity of hot water and its temperature in the tank and in controlling the activity of switching on to have hot water available on time and switching off later on.

In order to decrease the amount of energy that is required to heat and maintain the temperature of hot water during high demand times, high efficiency on demand commercial water heaters have been introduced, also known as instantaneous water heaters. These heaters produce hot water only when needed, so energy to maintain the hot water at a predetermined temperature during non-peak hours is eliminated.

While the above mentioned systems describe solutions relating to providing hot water for immediate consumption, none of them are concerned with modifying existing water heating systems into hot water systems available for instantaneous use.

There is therefore a need to provide a new and improved method of and apparatus for producing hot water wherein the disadvantages as outlined, are reduced or substantially overcome.

It is therefore an object of the present invention to provide method of and system for producing hot water from a hot water boiler system, which increases efficiency of hot water production when compared to other methods or systems.

Other objects and advantages of the invention will become apparent as the description proceeds.

### SUMMARY OF THE INVENTION

The present invention can be used as a retrofit kit to retrofit an existing boiler or hot water storage tank, or as an instantaneous water heater unit for other storage tanks (e.g., new manufactured ones). In other words, according to a preferred embodiment of the present invention, a flange which contains a sleeve, a thermostat or other suitable temperature sensing and controlling means, a water heating element, a flow switch and a hot water discharge outlet, is used to replace the existing flange of an existing boiler or water storage tank, as will be described hereinafter in further details.

The present invention is an instantaneous water heating unit for insertion into a hot water storage tank, which comprises: a) a sleeve adapted to be positioned on the bottom surface of said tank, said sleeve having an opening, at its top end, extending at least above the mid-height of said tank for discharging water from said tank into said sleeve; b) an electric water immersion heater positioned in said sleeve; means for controlling the operation of said heater; d) a hot water outlet transfer pipe extending downwardly from inside said sleeve and having a length sufficient to position the outlet of said pipe in an lowermost volume of said water storage tank, when said sleeve is inserted in said tank, the water within, said sleeve being heated on-demand by said heater while flowing through said sleeve; and e) a flow switch connected in line with said hot water outlet for sensing the opening of a hot water faucet.

According to an embodiment of the invention, the opening at the top of the sleeve is connected to a narrow hose. According to another embodiment of the invention, the narrow hose has a curved shape.

According to an embodiment of the invention, the means for controlling the operation of the heater is a thermostat. Preferably, the thermostat is positioned in the sleeve or the thermostat is positioned and integrated within the flow switch.

According to an embodiment of the invention, the means for controlling the operation of the heater is an external control unit and one or more temperature sensors. Preferably, at least one temperature sensor is integrated within the flow switch or in the sleeve. Preferably, the control unit comprises means for limiting the heating of the water for a predetermined period of time.

According to another embodiment of the invention, the instantaneous water heating unit further comprises an electronic faucet connected between a cold water inlet of the tank and the hot water outlet for pre-heating the water in said tank. The electronic faucet can be a solenoid valve or other suitable element as known to a person skilled in the art.

Preferably, the hot water storage tank is connected to a solar heating system.

According to an embodiment of the invention, the instantaneous water heating unit further comprises a metal rod for protecting the water tank against rust. Preferably, the metal rod is made of magnesium or aluminum.

Preferably, the instantaneous water heating unit further comprises a protecting element for protecting the instantaneous water heating unit against over heating of the water in the tank. Preferably, the protecting element is a thermostat located adjacent to hot water outlet or adjacent to the flow switch.

### BRIEF DESCRIPTION OF THE DRAWINGS

In the drawings:

FIG. 1A schematically illustrates an instantaneous water heating unit in accordance with one embodiment of the invention;

FIG. 1B schematically illustrates a bottom view of the instantaneous water heating unit in accordance with one embodiment of the invention;

FIG. 2 schematically illustrates the instantaneous water heating unit embedded within a solar water heating system in accordance with another embodiment of the invention;

FIG. 3 schematically illustrates the instantaneous water heating unit embedded within, a water tank and provided with pre-heating system, in accordance with another embodiment of the invention;

FIG. 4 schematically illustrates a control panel for controlling the water temperature; and

FIG. 5 schematically illustrates the instantaneous water heating unit embedded within a water tank, according to another preferred embodiment of the invention.

### DETAILED DESCRIPTION OF PREFERRED EMBODIMENTS

The term “sleeve” as used refers to an instantaneous water heater designed and intended to raise the temperature of water to a higher temperature for a specific purpose, such as for a bath or a shower.

The term “Instantaneous Water Heater” as used herein, refers to a water heater that generates hot water on demand.

The term “Heater” or “Water Heater” or “Hot Water Heater” as used herein, may refer to an on-demand water heater, a standard water heater, or a number of other embodiments for heating water to a desired temperature.

The term “Flow Switch” as used herein, may refers to any device or instrument suitable for monitoring, measuring, or recording the rate of flow, pressure, or discharge of a fluid, such as flow switches, flow meter and the like.

The present invention is an instantaneous water heating unit directed to be embedded within water tanks, either in tanks of new water heating systems or as a retrofit kit for existing one. Preferably, the instantaneous water heating unit of the invention is a sleeve which comprises one or more water heaters, a thermostat, a of water outlet and flow switch. The sleeve is a mechanism used for heating water supplied to the water tank from a water supply. Cold water may be introduced to the storage tank via a cold water supply conduit, which may contain one or more valves for regulation of the flow of water. The cold water flows through the cold water supply conduit to the storage tank. The cold water flows into the sleeve which contains one or more water heaters, preferably suitable for on demand heating. The water heater and/or the cold water supply conduit may have one or more safety valves. The water flow into the sleeve are being heated to a desired temperature whenever a demand for hot water is obtained (i.e., whenever the hot water faucet is opened).

The following embodiments are provided to further illustrate this invention and the manner in which it may he carried out. It will be understood, however, that the specific details given in the following embodiments have been chosen for purposes of illustration only and should not be construed as limiting the invention.

The storage tank may be commercially obtained from any vendor. One of ordinary skill in the art recognizes that a wide variety of storage tanks or similar devices could be utilized.

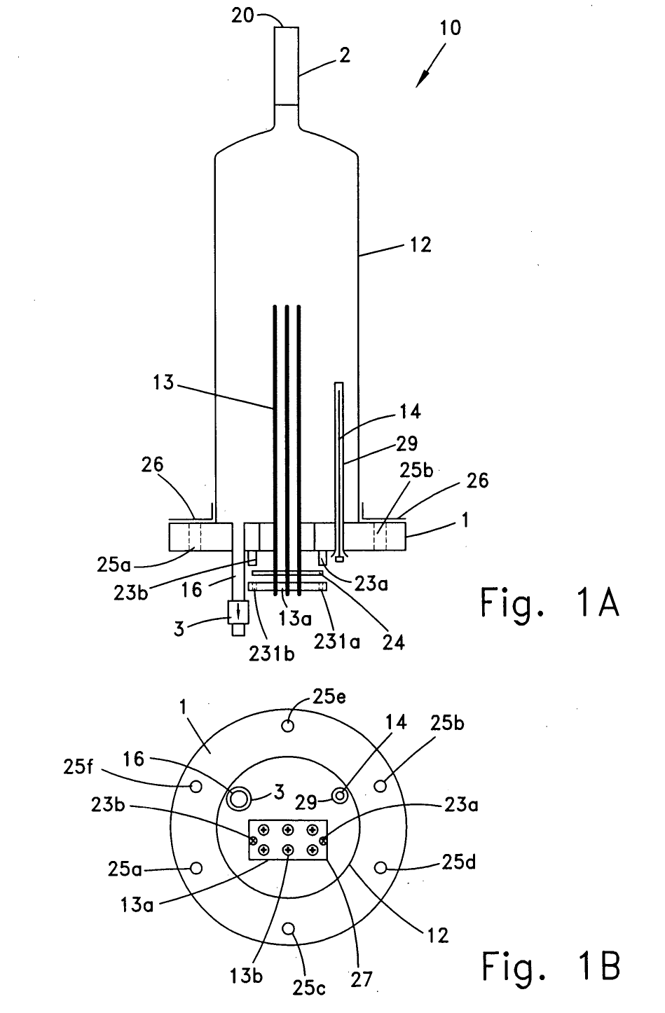

Referring now to the drawings, FIGS. 1A and 1B schematically illustrate an instantaneous water heating unit 10 adapted to be inserted into an insulated hot water storage tank, according to an embodiment of the present invention. FIG. 1A schematically illustrates a side view of unit 10 and FIG. 1B schematically illustrates a bottom view of unit 10. With reference to the figures, similar reference numbers have been used to identify similar parts.

Preferably, instantaneous water heating unit 10 is designed and manufactured in order to fit into a wide variety of standard water tank types, provided with an opening at their bottom for the insertion and connection of heating unit, such as common heating elements, either with or without a heating sleeve. Unit 10 can thus be supplied as a retrofit unit to be attached to such types of water tanks.

According to an embodiment of the present invention, instantaneous water heating unit 10 comprises a flange 1, at least one electric water immersion heater 13, means for controlling the operation of heater 13 (such as thermostat 14), a hot water outlet 16, sealing elements 24 and 26, holes, such as holes 25a-25f, for allowing to secure flange 1 of unit 10 to a water tank (e.g., by suitable screws), a flow switch 3 connected to the outlet 16 and a vertically-oriented sleeve 12 for covering heater 13 and thermostat 14. Preferably, but not limitatively, unit 10 comprises a housing 29 for covering thermostat 14. Thermostat 14 is inserted into housing 29 via an opening at the bottom of flange 1. Housing 29 provides better sealing properties while inserting thermostat 14. Not using housing 29 may result in leakage from sleeve 12 or flange 1.

Sleeve 12 has an elongated narrow hose 2 at its upper end having an opening 20, through which water enters into the inner space of sleeve 12, whenever water is discharged via outlet 16. When heater 13 is powered, the water flowing through sleeve 12 is instantaneously being heated. Preferably, heater 13 is powered whenever flow switch 3 senses that the hot water faucet which is piped to the outlet 16 via flow switch 3, is opened (i.e., “on demand” hot water state).

Thermostat 14 is used for regulating the temperature of the water within the sleeve 12 so that the water temperature will be maintained near a desired setpoint temperature. The thermostat does this by controlling the operation of heater 13. According to the output data from thermostat 14, heater 13 is switched “on” or “off” as needed to maintain the correct temperature. Thermostat 14 can be constructed in many ways and may use a variety of sensors to measure the temperature of the water, as is known to a skilled person in the art. The output of the sensor of thermostat 14 then controls the heating of the water. Thermostat 14 can be manually set before the installation of unit 10 within a water tank, or alternatively it can be provided with an external controlling unit for allowing a user to set a desired water temperature. Optionally, in case of using an external control unit, thermostat 14 is replaced with one or more temperature sensors (i.e., one or more temperature sensors are used instead of thermostat 14), thus the control and the limiting of the water heating is done via the external control unit and the data provided from such temperature sensors. Of course, other combinations of means and methods for controlling heater 13 can be used, as are known to a person skilled in the art.

Heater 13 can be connected to flange 1 by any suitable tightening and sealing means, as are known to a person skilled in the art. For example, base element 13a of heater 13 comprises holes 231a and 231b through which screws 23a and 23b are inserted correspondingly, wherein the end of each screw 23a and 23b is extended from the base 13a. A pair of suitable nuts (not shown) can be used to tighten the extended ends of the screws 23a and 23b, thereby securing base element 13a to flange 1. To enhance the sealing of unit 10, sealing element 24 is provided between flange 1 and the base 13a of heater 13. On the same principle, the entire unit 10 can be connected and secured to any suitable water storage tank (e.g. unit 10 can be tightened to the water storage tank via holes 25a-25f while using sealing element 26).

Usually, heater 13 is extended from its base 13a in order to allow the connection of the electrical power supply to heater 13. For example, the electrical power supply is connected to heater 13 via any suitable tightening elements, such as nut 13b (FIG. 1B), which is used to wire the electrical power supply to heater 13.

According to an embodiment of the invention, heater 13 can be easily replaced, whenever required, by disassembling the pair of nuts from screws 23a and 23b. This eliminates the need to replace the entire unit 10, but only heater 13. Furthermore, while replacing heater 13, only the water inside the sleeve and the water level above the end of the narrow hose will flow out, while the rest of the water in the water tank remains. This water saving provides an additional economic benefit to the instantaneous water heating unit 10 of the present invention.

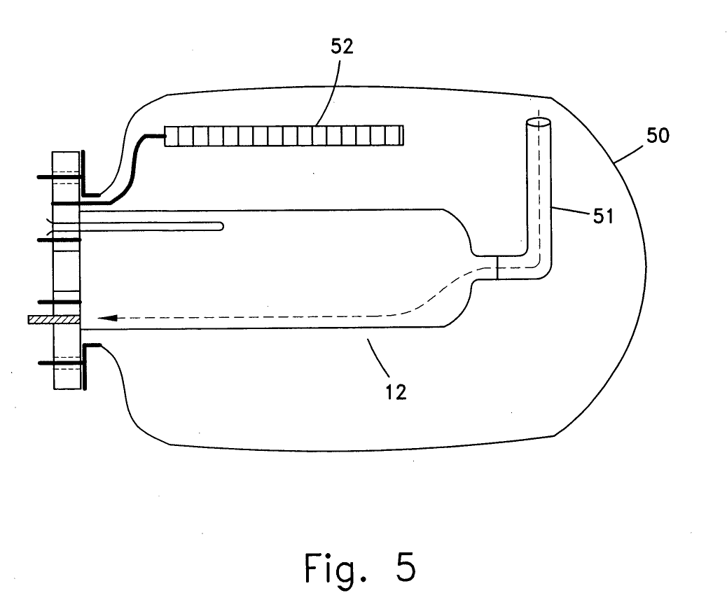

According to one embodiment of the invention, the narrow hose 2 is connected to sleeve 12 by any suitable means, such as by screwing. As there are many types of water tank having different sizes and different lengths, the length of hose 2 should therefore be chosen according to the dimension of the water tank. Preferably, opening 20 of hose 2 should be adjacent to the top of a water tank, in order to intake the hottest water which currently resides in the water tank (in particular, when the water is provided with a solar heating system). In a case when the water is fixed in a horizontal position, then the narrow hose should have a curved form, as shown for example by narrow hose 51 in FIG. 5.

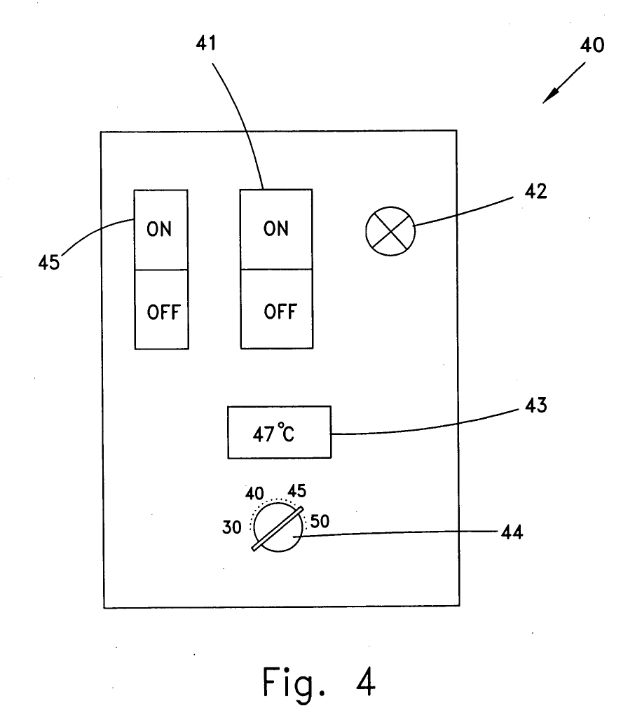

According to one embodiment of the invention, thermostat 1.4 can be controlled by any suitable controlling unit, through which the desired temperature of the water can be set and adjusted. For example, FIG. 4 schematically illustrates a control panel 40 of such a control unit. Control panel 40 comprises a main switch 41, indicator 42, display 43 and a temperature adjusting dial 44. Preferably, but not limitatively, such a control panel is positioned within the house or apartment for allowing a user to easily select the desired water temperature for a bath or shower.

In many types of water tanks, the installed heating unit is usually attached to the water tank via a flange, which is used as the base of the heating unit, on which the heating element and a suitable thermostat are located. Usually, the flange is secured to the bottom of the water tank by screws. Therefore, in order to fit into such existing water tank, unit 10 should be manufactured in such a way that the size of its flange 1 and the position of the holes 25a and 25b for the securing screws, should fit to the structure of the water tank.

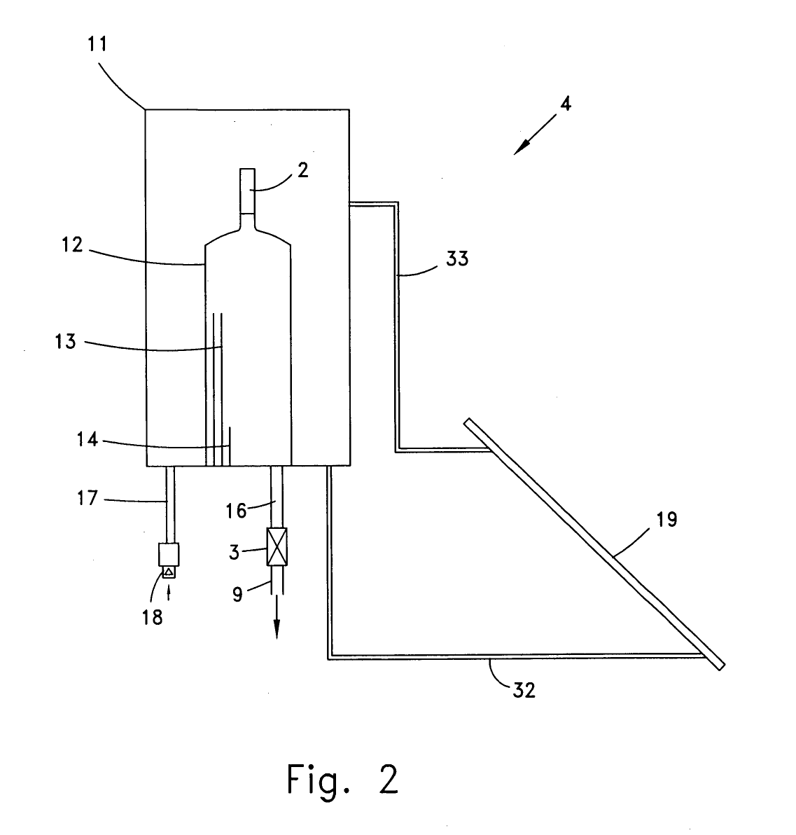

FIG. 2 schematically illustrates a solar water heating system 4 provided with instantaneous water heating unit 10, according to an embodiment of the present invention. System 4 comprises a water tank 11, unit 10 and typical solar collectors 19. The solar collector receives cold water from tank 11 via conduit 32 and provides heated water into tank 11 via conduit 33, as it done in typical solar heating systems.

Tank 11 receives cold water supply via conduit 17 (usually conduit 17 is piped to the municipal water line). Preferably, conduit 17 comprises a safety valve 18, located prior to the entrance of the cold water supply to tank 11. Safety valve 18 is used for preventing water form tank 11 to flow into conduit 17 (i.e., it is a type of a one way valve) as any volumetric expansion of water is relieved by slight reverse flow from the tank into water inlet pipe 17.

Outlet 16 is used as the consumer water outlet pipe. It has an outlet opening in the lowermost end of sleeve 12 (i.e., at the flange 1 which is positioned at the bottom of water storage tank 11, to draw therefrom the hottest water available (i.e., the instantaneous heated water). Such hot water may have been produced by the immersion heater 13, or by a solar energy system (FIG. 2), or by a combination thereof.

Pressure drop, due to water withdrawal for consumption, is immediately compensated by the entry of fresh supply water into tank 11.

When hot water is withdrawn through pipe 16, cold water enters inlet 17. Heat is transferred from the immersion heater 13 to the water passing in proximity to them and through outlet 16.

As aforementioned, the heating element sleeve 12 contains heating element 13 and thermostat 14, and water is supplied to heating element 13 after flowing from the top of storage tank 11 via inlet 20 leading into heating element sleeve 12. Preferably, sleeve 12 is made from plastic materials which can operate up to relatively high temperatures, such as 95° C. or above. The thermostat restricts the heating of the water flowing through the sleeve according to the temperature set by the user, e.g., via control panel 40 (i.e., in case of using an external control unit) or according to the predetermined temperature value that was set in the thermostat, usually to reasonable temperatures suitable for bath, such as 30°0 C. to 45° C.

The hot water outlet 16 is located preferably in the lowest portion of heating element sleeve 12, thereby allowing only currently heated water to flow out through outlet 18. As a result, this prevents water other than the water flowing across heating element 13 from being extracted via hot water outlet 16 during hot water consumption.

The size of hot water outlet 18 is preferably chosen to be in any standard size, e.g. having a diameter of about 19 mm, in order to permit a desired water flow rate at a limited pressure difference as the temperature of water flowing through heater 13 and further to hot water outlet 18 is substantially low (e.g., up to 45 C). These relatively low temperatures minimize the build up of scale and carbonate sediments.

Of course, if the water in tank 11 is pre-heated by the solar beating system 4, than depending on the temperature of the water in the tank, heater 13 can be operated partially or even will not be operated at all (of course, it depends on the setting of the thermostat 14) for substantially immediate use by the consumer during hot water consumption. In addition, in the present embodiment, outlet 16 of hot water consumption line or discharge is preferably positioned at a position lower than heating element 13, in order to ensure effective flow and heating of the volume of water flowing through heating element 13, whenever required.

Sleeve 12 and the heater 13 within it, is constructed and arranged such that the water flowing out of outlet 10 flows across the length of heating element 13 where the water is instantaneously heated by heating element 13.

In operation, thermostat 14 controls the operation of heating element 13 in order to produce a volume of hot water in hot water sleeve 12 between inlet 20 and outlet. 16, for substantially immediate use or consumption. Thus, when hot water is not consumed or extracted from hot water tank 11, water does not flow into the inner space sleeve 12.

When hot water is required by the consumer, flow switch 3 is activated, check valve shuts and hot water commences to exit tank 11 via sleeve through hot water outlet or discharge line 16, and cold water enters through pipe 17. Due to the fact that the inlet 20 of hot water discharge line 16 is positioned at a height lower than heater 13. the water exiting tank 11 will be drawn across heating element 13 prior to exiting hot water sleeve 12 in tank 11, thus ensuring that such water is heated by heater 13. If necessary, during hot water consumption, thermostat 14 serves to operate the heating element 13, such that there is boosting of hot water heating and the water is thus heated to the required temperature.

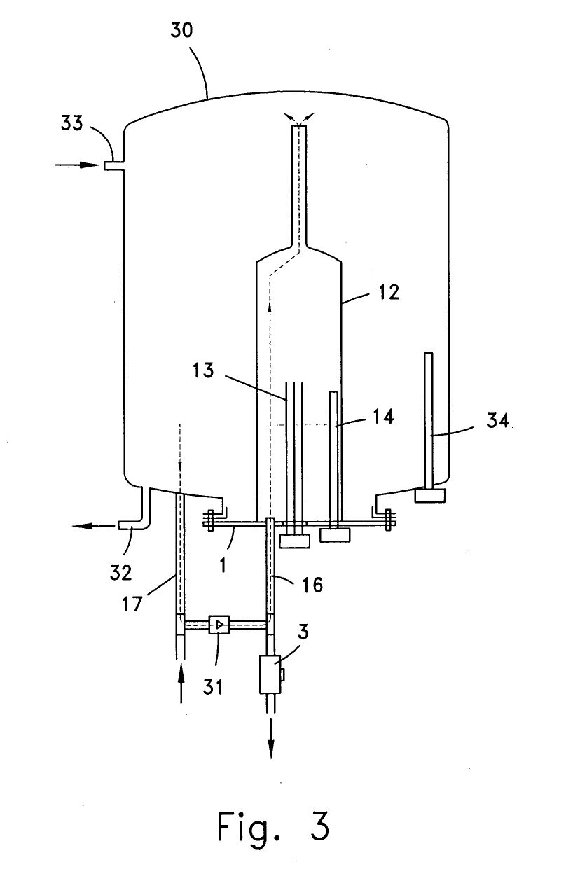

FIG. 3 schematically illustrates the instantaneous water heating unit embedded within a water tank and provided with a preheating system, according to another embodiment of the invention. In times when there is not enough solar power to heat the water in tank 30 or the water temperature is relatively low, then the temperature of the water in tank 30 can be warmed up by an additional thermostat, such as thermostat 34 which is located within tank 30 and outside of sleeve 12. It is sometimes necessary to pre-heat the water in the tank 30, in order to aid unit 10 to heat the water whenever an on-demand use will be required. The pre-heating is achieved by connecting an electronic, faucet 31, which bridges between inlet conduit 17 and outlet conduit 16. Whenever faucet 31 is active (i.e., a pre-heating of the water is required), it provides a close loop which circulates the water in tank 30 in such a way that the water flows out through conduit 17 into conduit 16, and from there it flows across the length sleeve 12 and heater 13 in an opposite direction to the on-demand consumption state, as was described hereinabove. Thus, the water flows across the entire volume of tank 30. In such a manner, a thermo-syphon flow pattern or cycle is produced across sleeve 12 and within the upper portion of hot water tank 30. When an on-demand hot water is required by the consumer, faucet 31 is turned off and the hot water exits tank 30 via hot water consumption line or discharge line 16, while cold water enters via conduit 17.

According to an embodiment of the invention, the pre-heating system can be activated by any suitable electronic circuit, such as pre-heating switch 45 in control panel 40 (FIG. 4).

According to another embodiment of the invention, sleeve 12 further comprises a metal rod for protecting the water tank against electrolysis and rust. Preferably, the rod is located adjacent to sleeve 12 (i.e., outside the sleeve). The metal rod can he made of any suitable material such as magnesium or aluminum (e.g., see magnesium rod 52 in FIG. 5). Of course, the metal rod could be located either in a horizontal water tank or vertical one.

It is to be emphasized that due to the aforementioned construction of unit 10, and the fact that the water in most heating scenarios will be lower than 50 Celsius degrees (in most cases people are used to bathing or showering with water in temperature ranges of 30-45 Celsius degrees), this results in reduced formation and deposition of carbonate inside the water tank and in particular, within the internal area of sleeve 12, heater 13 and further in the hot water lines. As a result, unit 10 can he used with almost any size of hot water outlet and further hot water lines. This may significantly extend the life of heater 13.

In addition, by using the method and apparatus of the present invention, the amount of time needed fir the heating element to reach the desired temperature is small compared to the amount of time needed for the apparatuses of the prior art, thus also ensuring that the carbonate production and deposition, when using the methods and apparatus of the present invention, will be substantially reduced.

Furthermore, by use of the present invention, hot water from the upper portion of the hot water boiler is used for providing substantially immediately hot water for consumption.

These measures contribute to shortening the time of operation of the heating element, thus reducing the amount of carbonate build-up and consequently maintaining the efficient operation of the heating element and prolonging its operating life. Thus, the operation of a hot water boiler system, in accordance with the present invention, will also bring about a savings in energy consumed.

While the above description refers to a horizontal and a vertical hot water tank and a suitable apparatus, the apparatus used for the vertical horizontal hot water tank can, if preferred, be used in a horizontal hot water tank, as described with respect to FIG. 5.

While sonic embodiments of the invention have been described h way of illustration, it will be apparent that the invention can be carried into practice with may modifications, variations and adaptations, and with the use of numerous equivalents or alternative solutions that are within the scope of persons skilled in the art, without departing from the spirit of the invention or exceeding the scope of the claims.

1. An instantaneous water heating unit for insertion into a hot water storage tank, comprising:
a. a sleeve adapted to be positioned on the bottom surface of said tank, said sleeve having an opening, at its top end, extending at least above, the mid-height of said tank for discharging water from said tank into said sleeve;
b. an electric water immersion heater positioned in said sleeve;
c. means for controlling the operation of said heater;
d. a hot water outlet transfer pipe extending downwardly from inside said sleeve and having a length sufficient to position the outlet of said pipe in an lowermost volume of said water storage tank when said sleeve is inserted in said tank, the water within said sleeve being heated on-demand by said heater while flowing through said sleeve; and
e. a flow switch connected in line with said hot water outlet for sensing the opening of a hot water faucet.

2. A unit according to claim 1, in which the opening at the top of the sleeve is connected to a narrow hose.

3. A unit according to claim 1, in which the narrow hose has a curved shape.

4. A unit according to claim 1, in which the means for controlling the heater is a thermostat.

5. A unit according to claim 4, in which the thermostat is positioned in the sleeve.

6. A unit according to claim 4, in which the thermostat is integrated within the flow switch.

7. A unit according to claim 1, in which the means for controlling the heater is an external control unit and one or more temperature sensors.

8. A unit according to claim 7, in which at least one temperature sensor is integrated within the flow switch.

9. A unit according to claim 8, in which the control unit further comprises means for limiting the heating of the water for a predetermined period of time.

10. A unit according to claim 1, further comprising an electronic faucet connected between a cold water inlet of the tank and the hot water outlet for pre-heating the water in said tank.

11. A unit according to claim 1, in which the hot water storage tank further comprises a solar heating system.

12. A unit according to claim 1, further comprising a metal rod for protecting the water tank against rust.

13. A unit according to claim 1, further comprising a protecting element for protecting the unit against over heating of the water in the tank.

14. A unit according to claim 13, in which the protecting element is a thermostat located adjacent to hot water outlet or to adjacent to the flow switch.

15. A unit according to claim 1, in which the flow switch is a flow meter.
